(19) United States
(12) Patent Application Publication
(10) Pub. No.: US 2010/0098356 A1
(43) Pub. Date: Apr. 22, 2010

(54) GAS THRUST BEARING AND ASSOCIATED PRODUCTION METHOD

(75) Inventors: Marco Giacchi, Waldstetten (DE); Klaus Lerchenmüller, Rettenberg (DE); Jan-Grigor Schubert, Senden (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/513,710

(22) PCT Filed: Oct. 29, 2007
(86) PCT No.: PCT/EP07/61604

§ 371 Date: Sep. 29, 2009

(30) Foreign Application Priority Data
Nov. 7, 2006 (DE) 10 2006 052 450.0

(51) Int. Cl. F16C 32/06; F16C 33/00; F16C 29/00; B21K 1/00

(52) U.S. Cl. 384/12; 29/898.02

(57) ABSTRACT

A gas-pressure bearing including a mounted body, a cavity accommodating the mounted body, and a bearing bush surrounding the cavity. The bearing bush includes a wall, a plurality of supply passages formed in the wall and configured such that compressed gas can be externally applied. The bearing bush includes a plurality of elements joined together, and at least some of the plurality of supply passages are formed by grooves in at least one surface of mutually facing surfaces of adjacent elements of the plurality of elements.

The present invention relates to a gas-pressure bearing having a bearing bush that surrounds a cavity for accommodating a mounted body and in whose wall are formed a multiplicity of passages to which compressed gas can be externally applied, and to a method for producing a gas-pressure bearing of such type. A gas-pressure bearing of such type and a method for producing it are known from EP 0 708 262 A1.

How the gas-pressure bearing functions is based on compressed gas penetrating through the passages into a gap between the bearing bush and the body mounted therein and creating an overpressure in the gap. Said gap has to be narrow to exhibit sufficient flow resistance necessary for producing the overpressure. The supply passages must also be narrow, on the one hand in order to limit the compressed gas throughput rate of the bearing and, on the other, so that, if an excursion executed by the mounted body results locally in a narrowing of the gap between the body and bearing bush and correspondingly in compressing of the gas in the narrowed region, the pressure increase will be relieved through the gas's flowing back out of the gap to the outside through the supply passages.

The production of sufficiently narrow supply passages with a diameter particularly in the 25-μm range and below presents significant technical difficulties. EP 0 708 262 A1 cited in the introduction discloses how to bore such passages by means of a laser beam. That approach is an unsatisfactory one for a number of reasons: On the one hand, each passage has to be bored in a time-consuming manner individually, making production expensive; on the other hand, while achieving a large ratio between a passage's length and diameter is desirable for preventing turbulence, the layer thickness able to be bored with a laser is limited by the fact that the diameter of the laser beam in front of and behind a focus diverges the more the sharper the focus is, so that a small boring diameter cannot be controllably maintained along the entire passage length if the boring depth is too great. Added to that is the tendency of the material removed by the laser to be deposited on the side walls of the bored hole if the boring depth is too great. Weakened regions sufficiently thin to enable boring therein with the laser then have to be formed in advance on the walls of the bearing bush. However, said regions substantially adversely affect the bearing's loading capacity and resistance to deformation.

The object of the present invention is to disclose a gas-pressure bearing and a method for producing it that will each enable economical manufacturing of a gas-pressure bearing that is highly resistant to deformation despite the narrow cross-section of the supply passages.

Said object is achieved in the case of a gas-pressure bearing having a bearing bush that surrounds a cavity for accommodating a mounted body and in whose wall are formed a multiplicity of supply passages to which compressed gas can be externally applied on the one hand by assembling the bearing bush by joining together a plurality of elements and forming at least some of the supply passages by means of grooves in mutually facing surfaces of in each case adjacent elements. It will be possible to maintain a very narrow cross-section for the passages over a long—in principle any—length by realizing them initially in the form of surface grooves. The elements will consequently be able to have a considerable wall thickness and to exhibit a correspondingly high dimensional stability.

To make finished passages out of the grooves it can be provided for the mutually facing surfaces of in each case adjacent elements to mutually touch.

Alternatively, a sealing washer, preferably rectangular in cross-section, can also be inserted in each case between the mutually facing surfaces. A sealing washer of such type can exhibit a certain degree of plastic deformability enabling it to equalize wide-area, low-depth unevenness on the mutually opposite surfaces but without, in doing so, penetrating into the grooves and causing them to become worn or narrower.

The elements are arranged preferably one following the other in the longitudinal direction of the bearing bush.

To make it easier to correctly assemble the elements it can be provided for the mutually adjacent elements to mutually engage in a form-fit manner.

It is particularly preferred for a front face belonging to one of the elements and having the grooves to be plugged into a recess in another element.

So that the grooves on the front face will be reliably supplied with compressed gas, they expediently run in an overall bent fashion across the front face and a lateral surface of the hollow-cylindrical one element along at least a part of its axial extent.

The bearing bush is held in a tubular housing as a simple way to ensure that the individual elements are kept together.

The elements of the bearing bush are preferably at least three in number so there will be at least two pairs of mutually opposite surfaces of elements on which the passages can be formed. The elements of the bearing bush are furthermore preferably an odd number so there can be one or more groups of three adjacent elements. The central element in a group of such type preferably has a smaller outer dimension than both other elements touching it so there will be space around the central element for a supply channel that feeds supply passages extending between the central element and the two supply passages adjacent thereto with compressed gas.

For feeding the supply passages with compressed gas from a longitudinal end of the gas-pressure bearing, a compressed-gas supply channel can be provided that extends in the longitudinal direction and is delimited by the elements of the bearing bush and by the housing. A compressed-gas supply line that extends through the housing can alternatively also be provided, one of whose ends is on an end face of the housing and the other of which is at the level of the central element.

The grooves can be formed in a simple and economical way through deformation. That will enable all the grooves provided on one of two mutually facing surfaces to be produced in a minimum time and at minimal cost using simple, long-life tools.

The object is further achieved by means of a method for producing a gas-pressure bearing, said method comprising the following steps:
a) Providing a plurality of elements that can be joined together to form a bearing bush surrounding a cavity;
b) producing grooves in at least one surface of at least one of the elements, which surface in the joined condition faces a surface of an adjacent element; and
c) joining the elements together to form the bearing bush.

The mutually facing surfaces can be brought into direct mutual contact or a sealing washer can be inserted between them.

The grooves are produced preferably by embossing.

A further step of the method can be putting the elements into a tubular housing.

Further features and advantages of the invention will emerge from the following description of exemplary embodiments with reference to the attached figures, in which:

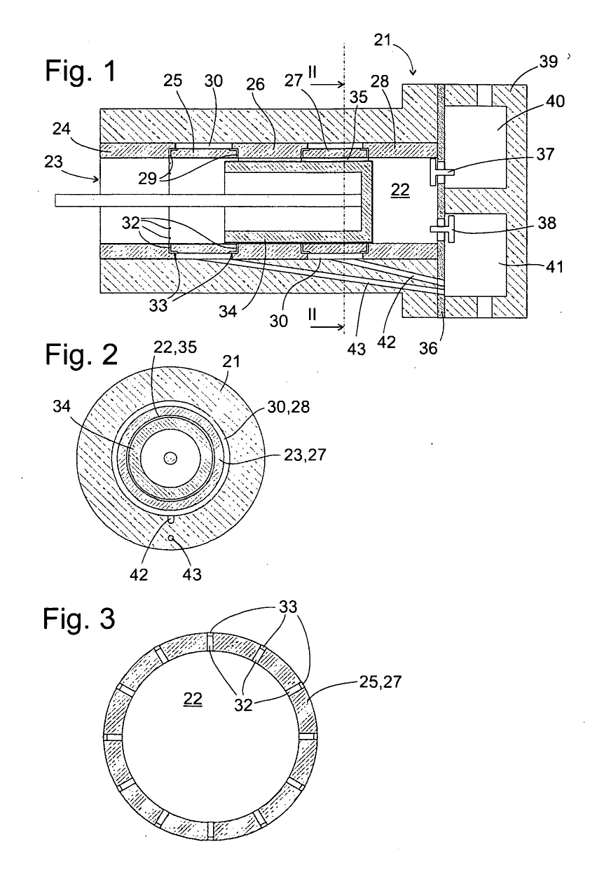

FIG. 1 shows a schematic axial section through a compressor having a compressed-gas bearing according to the present invention;

FIG. 2 shows a section through the compressor shown in FIG. 1 along the plane identified in FIG. 1 by II-II;

FIG. 3 shows an end-side view of an element of the bearing bush shown in FIG. 1;

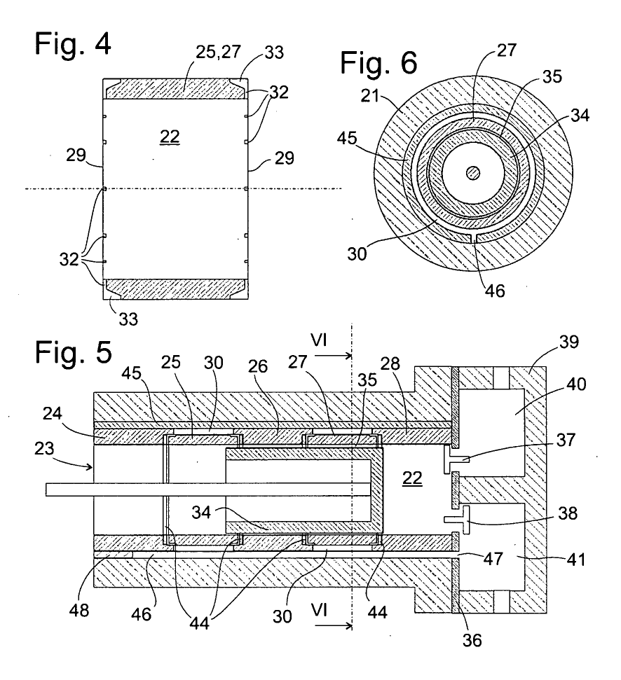

FIG. 4 shows an axial section through the element shown in FIG. 3;

FIG. 5 shows a section, analogous to FIG. 1, through a compressor having a gas-pressure bearing according to a second embodiment of the invention;

FIG. 6 shows a section along the plane identified in FIG. 5 by VI-VI; and

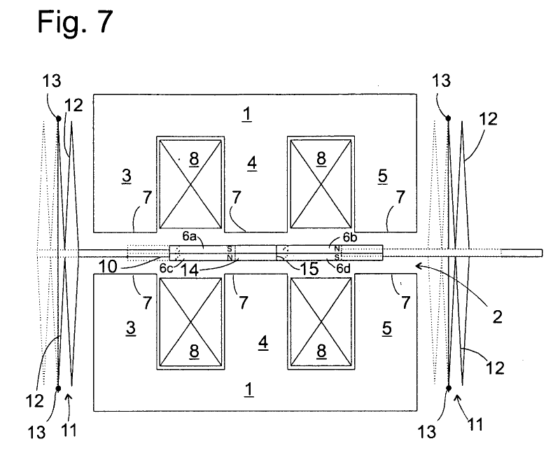

FIG. 7 shows a schematic of a drive unit for the compressor.

The compressor through which an axial section is shown in FIG. 1 and a radial section in FIG. 2 and which in the present instance is embodied as a linear compressor has a housing 21 accommodating a hollow-cylindrical bearing bush 23 that delimits a working chamber 22. The bearing bush 23 has been assembled by joining together an odd number—in this case five—of annular or hollow-cylindrical elements 24, 25, 26, 27, 28 that follow each other in the axial direction. The two outer elements 24, 28 and the central element 26 in the arrangement each have on mutually opposite front faces 29 annular recesses into which end regions of the elements 25, 27 situated between them engage. The elements 24 to 28 all have exactly the same inside diameter so that their inner surfaces will be joined flush. The elements 25, 27 have an outside diameter in each case smaller than that of the adjacent elements 24, 26, 28 so that the bearing bush 23 has on its outer surface two circumferential channels 30 each at the level of the elements 25, 27.

The outer surfaces of the elements 24, 26, 28 are held radially free of play in contact with the inner surface of the tubular housing 21 and in the axial direction are secured in position in a fictionally engaged manner by, for example, shrinking the housing 21 onto the elements 24, 26, 28. The elements 25, 27 are in turn secured in position through engagement without play into the recesses of the elements 24, 26, 28.

As can be seen in FIG. 3, the elements 25, 27 are provided on their front faces 29 with a multiplicity of radially oriented grooves 32 of which in each case an inner end feeds into the working chamber 22 and an outer end transitions into a groove 33 extending axially across the outer surface of the element 25 or, as the case may be, 27. The width and depth of the grooves 32, 33 is in each case at most a few tens of micrometers; their length can be a few millimeters. The axial grooves 33 will each extend from the recesses of the elements 24, 26, or 28 when the elements 24 to 28 have been joined together. The channels 32, 33 will together with the opposite front faces 29 of the elements 24, 26, 28 thus form supply passages via which channels 30 communicate with the working chamber 22.

A piston 34 is arranged in an axially displaceable manner in the working chamber 22. The diameter of the piston 34 is approximately 30 mm and is approximately 10 to 20 μm smaller than the inside diameter of the elements 24 to 28 so that when the piston 34 is arranged concentrically relative to the bearing bush 23 a gap 35 that is 5 to 10 μm in width will separate the piston 34 circumferentially from the inner surface of the bearing bush 23. Some of the grooves 32 feed into said gap 35.

The working chamber 22 is sealed at an end face by means of a spring plate 36 welded on to a circumferential flange of the housing 21. Formed in the spring plate 36 are non-return valves 37, 38 that allow flow in mutually opposite directions. Mounted on a side of the spring plate 36 facing away from the working chamber 22 is a cap 39 in which are recessed two chambers 40, 41. A motion of the piston 34 away from the spring plate 36 draws gas out of the chamber 40 through the valve 38 into the working chamber 22. A next motion of the piston 34 toward the spring plate 36 condenses the gas in the working chamber 22 and finally presses it through the valve 38 into the chamber 41.

Bored compressed-gas supply lines 42, 43 extend from the chamber 41 through the spring plate 36 and tubular housing part 31 to the channels 30. An overpressure in the chamber 41 will spread via the compressed-gas supply lines 42, 43 into the channels 30 so that gas will flow through the grooves 33, 32 back into the working chamber 22 and thereby form a gas cushion that guides the piston 34 without contact with the bearing bush 23.

As can readily be seen, a compressor having a reduced length or a reduced number of supply passages can easily be realized by omitting the elements 26, 27 and inserting the element 25 directly into the recess in the element 28. A compressor having a longer length and/or a larger number of supply passages can be provided analogously by inserting additional pairs of elements 26, 27 and creating compressed-gas supply lines feeding the respectively resulting channels 30.

FIG. 4 shows an enlarged axial section through one of the elements 25, 27. It can be seen in said section that the depth of the grooves 33 extending across the outer surface of the element 25, 27 reduces as their distance from the front face 29 from which they start increases. That groove shape has two advantages: On the one hand it enables the grooves 32, 33 to be produced in a joint work process through embossing with the aid of dies (not shown) that are pressed against the front faces 29 of the element 25, 27; on the other hand, unnecessarily abrupt deflecting of the gas stream at the transition between the grooves 32, 33 resulting in turbulence and a drop in pressure will be obviated through their meeting at an obtuse angle.

FIG. 5 shows a section, analogous to that shown in FIG. 1, though a second embodiment of a gas-pressure bearing, which embodiment is distinguished from that shown in FIG. 1 by two mutually independently realizable features. The first feature is the presence of sealing washers 44 that are rectangular in cross-section and each located in the recesses in the elements 24, 26, 28 such as to cover the front faces 29 of the engaging elements 25, 27. The sealing washers 44 are slightly plastically deformable so that while not penetrating into the grooves 32 and narrowing the cross-section thereof they can nonetheless equalize wide-area, low-amplitude unevenness between the mutually opposite front faces of the elements and thereby prevent compressed gas from reaching the working chamber 22 from one of the channels 30 through gaps located away from the grooves 32, 33.

The second feature is that the elements 24 to 28 forming the bearing bush 23 are accommodated in a slotted cylindrical bushing 45 that is in turn applied against the inner surface of the tubular housing part 31. Because the slot 46 in the bushing 45 is in alignment with a passage 47 in the spring plate 36 and is tightly sealed at an end facing away from the spring plate 36 by, for example, a synthetic resin plug 48, compressed gas from the chamber 41 can reach all channels 30 of the bearing bush 23 without their each having to be made accessible through individual bored holes 40 or, as the case may be, 41, as shown in FIG. 1. The embodiment shown in FIG. 5 will therefore be expedient particularly if the bearing bush 23 has been assembled from a large number of elements following each other.

FIG. 7 shows a schematic of a drive unit that can be used for driving the oscillating motion of the piston 36. Said unit includes two E-shaped yokes 1 having three arms 3, 4, 5 situated mutually opposite in pairs. The mutually facing ends of the arms 3, 4, 5 form in each case pole shoes 7 delimiting an air gap 2. An exciter winding 8 is in each case attached around the central arms 4. Current can be applied to the two exciter windings 8 by a control circuit, with the current direction in the two exciter windings 8 being in each case established such that the mutually opposite pole shoes 7 of the central arms 4 form unlike magnet poles. The pole shoes of the outer arms 3 and 5 form magnet poles in each case unlike that formed by the adjacent central arm 4.

In the air gap 2 an armature 10 is suspended from two springs 11 such as to be mobile in a reversing manner between a top and bottom reversal point (or a right-hand and left-hand reversal point in the representation shown in FIG. 7). The position of the armature 10 at the top reversal point is shown by means of unbroken lines and its position at the bottom reversal point by means of dashed lines. The springs 11 are each leaf springs punched out of a sheet-metal plate and having a plurality of zigzagging arms 12. The arms 12 of a spring 11 extend in each case as mirror images of each other from a central point of action on the armature 10 to suspension points 13 on a fixed frame (not shown) to which the yokes 1 and the compressor are anchored. The springs 11 will owing to that embodiment be difficult to deform in the longitudinal direction of the armature 10 and in any direction orthogonal thereto so will reversibly guide the armature 10 in its longitudinal direction.

The substantially rod-shaped armature 10 includes in its central region a four-pole permanent magnet 14. Whereas the magnet 14 will be positioned centrally in the air gap 2 and a magnetic limit 15 between its—in FIG. 1—left-hand and right-hand poles will run centrally through the central arms 4 when the springs 11 are in a relaxed position in which the arms 12 of each spring 11 are positioned substantially in the same plane, the armature 10 will be deflected depending on the current direction to the left or right when a current is applied to the windings 8.

1-19. (canceled)

20. A gas-pressure bearing comprising:
a mounted body;
a cavity accommodating the mounted body; and
a bearing bush surrounding the cavity,
wherein the bearing bush includes:
a wall;
a plurality of supply passages formed in the wall and configured such that compressed gas can be externally applied,
wherein the bearing bush includes a plurality of elements joined together,
wherein at least some of the plurality of supply passages are formed by grooves in at least one surface of mutually facing surfaces of adjacent elements of the plurality of elements.

21. The gas-pressure bearing as claimed in claim 20, wherein the grooves are formed in the mutually facing surfaces of each of the adjacent elements of the plurality of elements.

22. The gas-pressure bearing as claimed in claim 20, wherein the mutually facing surfaces of the adjacent elements mutually touch.

23. The gas-pressure bearing as claimed in claim 20, comprising:
a sealing washer between the mutually facing surfaces of each pair of adjacent elements.

24. The gas-pressure bearing as claimed in claims 20, wherein the elements are arranged one following another in a longitudinal direction of the bearing bush.

25. The gas-pressure bearing as claimed in claim 20, wherein the mutually adjacent elements mutually engage in a form-fit manner.

26. The gas-pressure bearing as claimed in claim 25, wherein a front face of one of the plurality of elements and having the grooves is plugged into a recess in another element of the plurality of elements.

27. The gas-pressure bearing as claimed in claim 26, wherein the one of the plurality of elements is a hollow-cylindrical element, and
wherein the grooves run in a bent fashion across the front face and a lateral surface of the hollow-cylindrical element.

28. The gas-pressure bearing as claimed in claim 20, comprising:
a tubular housing holding the bearing bush.

29. The gas-pressure bearing as claimed in claim 28, wherein the plurality of elements of the bearing bush includes at least three elements, and
wherein an outer dimension of a central element of a group of the at least three elements is less than an outer dimension of each other element of the at least three elements touching the central element.

30. The gas-pressure bearing as claimed in claim 28, comprising:
at least one compressed-gas supply channel extending in a longitudinal direction and delimited by the plurality of elements of the bearing bush and by the tubular housing.

31. The gas-pressure bearing as claimed in one of claims 29, comprising:
a compressed-gas supply line extending through the tubular housing, the compressed-gas supply line having one end on an end front face of the housing and another end at a level of the central element.

32. The gas-pressure bearing as claimed in claim 20, wherein the grooves are formed by deformation.

33. The linear compressor having a gas-pressure bearing as claimed in claim 20.

34. A method for producing a gas-pressure bearing, said method comprising:
providing a plurality of elements configured to be joined together to form a bearing bush surrounding a cavity;
producing grooves in at least one surface of at least one of the plurality of elements, wherein the at least one surface of the at least one of the plurality of elements faces a surface of an adjacent element of the at least one of the plurality of elements when the at least one of the plurality of elements is joined to the adjacent element of the at least one of the plurality of elements; and
joining the plurality of elements together to form the bearing bush.

35. The method as claimed in claim 34, wherein the joining includes bringing mutually facing surfaces of the at least one of the plurality of elements and the adjacent element of the at least one of the plurality of elements into mutual contact.

36. The method as claimed in claim 34, wherein the joining includes inserting a sealing washer between the mutually facing surfaces.

37. The method as claimed in one of claims 34, wherein producing the grooves includes embossing the grooves.

38. The method as claimed in one of claims 34, comprising:
putting the plurality of elements into a tubular housing.

39. A gas-pressure bearing comprising:
a bearing bush surrounding a cavity; and
a piston arranged in an axially displaceable manner in the cavity;
wherein the bearing bush includes:
a plurality of elements joined together; and
a plurality of supply passages formed in a wall of the plurality of elements and configured to admit compressed gas applied from an exterior of the plurality of elements,
wherein each adjacent pair of elements of the plurality of elements includes a pair of mutually facing surfaces, and
wherein at least one of the plurality of supply passages is formed by a groove in at least one of the pair of mutually facing surfaces of the each adjacent pair of elements of the plurality of elements.
